(19) United States
(12) Patent Application Publication
(10) Pub. No.: US 2024/0165641 A1
(43) Pub. Date: May 23, 2024

(54) ATOMIZING NOZZLE ARRANGEMENT

(71) Applicant: Danfoss A/S, Nordborg (DK)

(72) Inventors: Steen Gaardsted KRISTENSEN, Nordborg (DK); Leif Boesen BONNERUP, Nordborg (DK); Preben NØRSKOV, Nordborg (DK)

(21) Appl. No.: 18/551,082

(22) PCT Filed: Apr. 12, 2022
(86) PCT No.: PCT/EP2022/059756

§ 371 Date: Sep. 18, 2023

(30) Foreign Application Priority Data
Apr. 16, 2021 (EP) 21168960.9

(51) Int. Cl. B05B 1/30

(52) U.S. Cl. CPC B05B 1/302; B05B 1/3006

(57) ABSTRACT

An atomizing nozzle arrangement (1) includes a housing (2, 3) having an inlet (23), a valve seat (6), a valve element (7) interacting with the valve seat (6), restoring means (8) acting on the valve element (7), and an orifice (9). In such an atomizing nozzle arrangement dripping should be avoided. To this end, the valve element (7) is fixed in a guidance element (12) which is guided in a bore (16) of the housing (2, 3).

### CROSS-REFERENCE TO RELATED APPLICATIONS

This application is a National Stage application of International Patent Application No. PCT/EP2022/059756, filed on Apr. 12, 2022, which claims priority to European Patent Application No. 21168960.9, filed on Apr. 16, 2021, each of which is hereby incorporated by reference in its entirety.

### TECHNICAL FIELD

The present invention relates to an atomizing nozzle arrangement comprising a housing having an inlet, a valve seat, a valve element interacting with the valve seat, restoring means acting on the valve element, and an orifice.

### BACKGROUND

Such a nozzle arrangement is used, for example, to create a fine atomized spray of a liquid. Such a nozzle arrangement can be used, for example, in relation to humidification, dust suppression, pest control, disinfection, cooling and other purposes. The orifice can also be termed “nozzle”.

In order to create the fine atomized spray, a liquid which is to be atomized, is supplied to the inlet with a defined or given pressure sufficient to atomize the liquid. This pressure opens the valve, i.e., produces a force on the valve element exceeding the force of the restoring means and lifts off the valve element from the valve seat, so that the liquid can reach the orifice in which it is atomized. When the atomizing should be stopped, the pressure at the inlet is lowered, the restoring means will press the valve element against the valve seat and the valve should close perfectly, when the inlet pressure is fully removed or gets below a lower limit in order to avoid dripping.

### SUMMARY

The object underlying the invention is to have an atomizing nozzle arrangement without dripping.

This object is solved in that the valve element is fixed in a guidance element which is guided in a bore of the housing.

A requirement for a tight closing valve is that the valve element comes into a predefined position in relation to the valve seat when the valve is closed. This requires usually a rather high precision in manufacturing the valve. However, such a high precision produces costs. When the valve element is fixed in a guidance element which is guided in a bore of the housing, such high precision in producing the valve of the nozzle arrangement can be avoided. The guidance element guides the valve element and secures that the valve element can be brought into contact with the required precise positioning. Thus, the addition of the guidance element contributes to the tightness of the nozzle arrangement and to the avoidance of dripping.

In an embodiment of the invention at least one flow channel is formed between the guidance element and the housing. Thus, no additional channels bypassing the guidance element are necessary.

In an embodiment of the invention the bore has a circular cross section and the guidance element has a form adapted to the circular cross section with a predetermined tolerance. A circular cross section of the bore can be produced by drilling. The circular cross section of the guidance element can simply be produced by turning. The circular cross section of the guidance element has a diameter which is slightly smaller than the diameter of the circular cross section of the bore, so that the guidance element can be moved in the bore with low friction, however, with sufficient guiding or alignment. The tolerance can be in the magnitude of some hundredth parts of millimetres.

In an embodiment of the invention the guidance element has at least one flattened section on its circumference, the flattened section extending over the axial length of the guidance element. The flattened section forms a channel between the wall of the bore and the guidance element through which the liquid can pass from the valve to the orifice.

In an embodiment of the invention the valve element comprises at least on a side facing the valve seat a symmetrically curved surface. Such a symmetrically curved surface allows that part of the valve element can be inserted into the valve seat, so that a sealing line can be achieved which contributes to a tightness of the valve.

In an embodiment of the invention the valve element comprises a spherical surface, at least in an area facing the valve seat. The spherical surface is a simple form of a symmetrically curved surface. Such a spherical surface can in a simple manner be realized when the valve element is in form of a ball.

In an embodiment of the invention the valve element is made of a elastically deformable material. Such material can be, for example, rubber or a similar plastic material. The elastically deformable material has two advantages. On the one hand, it can be pressed against the valve seat to achieve the required tightness. On the other hand, such a deformable valve element can be easily mounted in the guidance element.

In an embodiment of the invention the guidance element comprises a longitudinal channel extending from the valve element to the opposite side of the guidance element. When the valve element is mounted in the guidance element, there is no closed volume between the guidance element and the valve element, so that there is no trapped fluid in such a closed volume which can expand to press the valve element out of the guidance element.

In an embodiment of the invention the valve element is frictionally or in a form-locking way held in the guidance element. Thus, no further means for fixing the valve element in the guidance element are necessary.

In an embodiment of the invention the housing comprises a first housing part and a second housing part, wherein the second housing part comprises an outer thread in engagement with an inner thread in the first housing part, wherein the second housing part comprises an inlet channel connected to the inlet and the valve seat is formed at an inner end of the inlet channel. Thus, the valve seat can be produced in a simple way. It is basically only necessary to form the inlet channel.

In an embodiment of the invention the valve seat comprises a conical or curved form. In particular, in connection with a spherical surface of the valve element, such a cone form increases the sealing line between the valve seat and the valve element.

In an embodiment of the invention a cone element is arranged in the housing between the guidance element and the orifice, wherein the restoring means are arranged between the cone element and the guidance element. The cone element is used to guide the liquid from a radially outer part of the flow path to the orifice which is arranged centrically. The cone element can also be used to set the liquid which should be atomized in a circular motion.

In an embodiment of the invention the restoring means are arranged in a recess in the cone element and/or in a recess in the guidance element. The restoring means can be, for example, in form of a spring. The length of the restoring means is at least partly accommodated in the cone element and/or in the guidance element, so that the length of the nozzle arrangement can be kept small.

In an embodiment of the invention the cone element is held in the first housing part by means of the second housing part. This simplifies the mounting of the nozzle arrangement.

In an embodiment of the invention the bore comprises at least one groove extending over the length of the bore. This bore forms part of a flow path from the valve seat to the orifice for the liquid to be atomized. The groove can be used in addition to the flattened section of the guidance element or alternatively to the flattened section.

### BRIEF DESCRIPTION OF THE DRAWINGS

Preferred embodiments of the invention will now be described with reference to the drawing, in which:

FIG. 1 shows an exploded view of a first embodiment of the invention,

FIG. 2 shows a view of the nozzle arrangement, partly in section, where the valve is closed and

FIG. 3 shows a view of a second embodiment of the nozzle arrangement, partly in section, where the valve is open.

### DETAILED DESCRIPTION

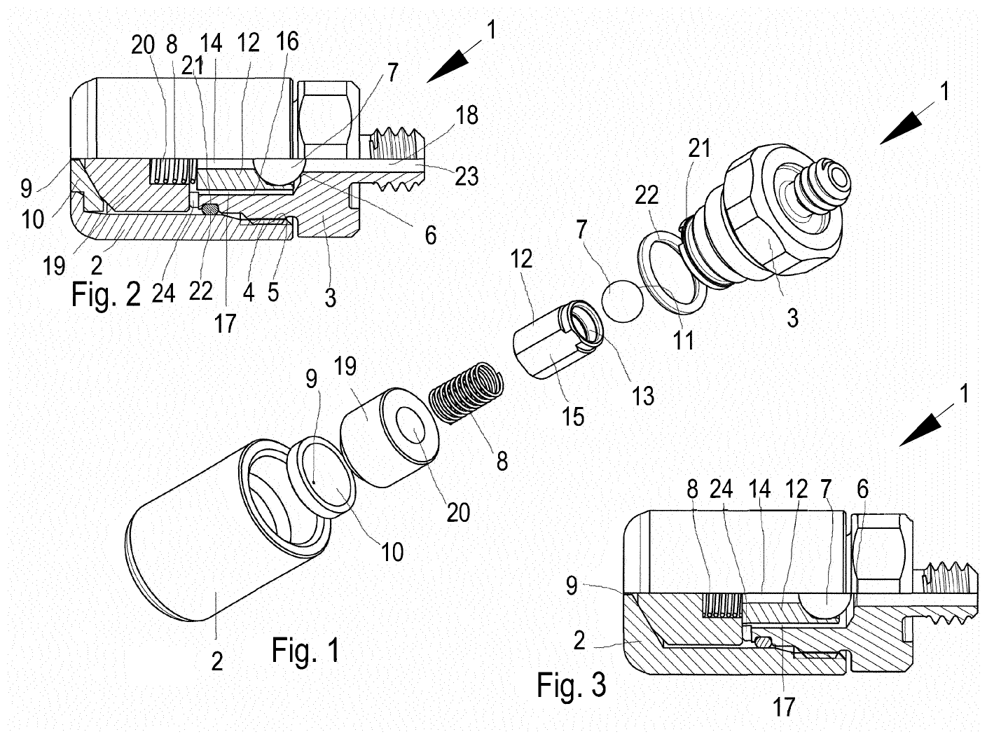

FIG. 1 shows an exploded view of an atomizing nozzle arrangement 1 comprising a housing having a first housing part 2 and a second housing part 3. As can be seen in FIG. 2, the second housing part 3 comprises an outer thread 4 which is screwed into an inner thread 5 in the first housing part 2.

The nozzle arrangement 1 comprises furthermore a valve seat 6 and a valve element 7 interacting with the valve seat. Furthermore, restoring means in form of a spring 8 are provided. The spring 8 acts on the valve element 7. Furthermore, the atomizing nozzle arrangement 1 comprises an orifice 9 which is, in the embodiment shown in FIGS. 1 and 2, arranged in a orifice disk 10, wherein the orifice disk 10 is inserted into the first housing part 2.

The valve element 7 comprises a symmetrically curved surface 11 at least in an area facing the valve seat 6. Such a symmetrically curved surface 11 can be a spherical surface. In a preferred embodiment of the invention this is realized by using a ball as valve element 7.

The valve element 7 is made of a elastically deformable material. Such a material can be, for example, rubber or a plastic material. The use of an elastically deformable material increases the tightness of the valve formed by the valve seat 6 and the valve element 7.

The valve element 7 is fixed in a guidance element 12. To this end, the guidance element 12 comprises a receptacle 13 for the valve element 7 into which the valve element 7 can be pressed. The valve element 7 can be held in the guidance element 12 by friction or the receptacle 13 can have an outer rim which is slightly deformed radially inwardly, so that the valve element 7 is held in a form-locking way in the guidance element 12.

The receptacle 13 is connected to the opposite side of the guidance element by means of a longitudinal channel 14, so that air in the receptacle 13 can be displaced to the other end of the guidance element 12 through the longitudinal channel 14 when the valve element 7 is mounted in the guidance element 12.

The guidance element 12 comprises at least one flattened side 15. However, it is preferred that the guidance element comprises more than one flattened side 15, wherein the flattened sides 15 are distributed symmetrically in circumferential direction of the guidance element 12.

The flat surfaces 15 can have an extension in circumferential direction which is so large that adjacent flat surfaces 15 contact each other. The guidance element 12 then has a section in form of a polygon, wherein the edges of the polygon are arranged on a circle. The edges or corners can be rounded.

The second housing element 3 comprises a bore 16 in which the guidance element 12 is guided. Apart from the flattened side 15 or the flattened sides 15 the guidance element 12 has a circular cross section. The bore 16 has also a circular cross section. The diameter of the guidance element 12 is adapted to the diameter of the bore 16, i.e., the diameter of the guidance element 12 is a few hundredth parts of millimetres smaller than the diameter of the bore 16. Such a narrow tolerance allows a good movement of the guiding element 12 in the bore 16 with low friction, however, defines the position of the guidance element 12 in the bore 16 with sufficient precision. Since the valve element 7 is held in the guidance element 12, such narrow tolerances define also the position of the valve element 7 with respect to the valve seat 6 with sufficient precision.

The flat surfaces 15 form a space 17 between the inner wall of the bore 16 and the guidance element 12, through which a liquid can flow once the valve element 7 has been lifted off the valve seat 6 and the valve is open as it is shown in FIG. 3.

The second housing part 3 comprises an inlet channel 18 which ends in the bore 16. The transition between inlet channel 18 and bore 6 forms the valve seat 6. In a preferred embodiment of the invention, the valve seat 6 can be machined to produce a conical or curved form of the valve seat 6.

A cone element 19 is mounted in the first housing part 2. The cone element holds the orifice disk 10.

The cone element 19 comprises a recess 20 accommodating the spring 8. In a way not shown, a recess can also be formed in the guidance element 12, for example by enlarging the diameter of the longitudinal channel 14 over a part of its length, so that the spring 8 can also be accommodated in the guidance element 12. It is also possible to use only a recess in the guidance element 12 to accommodate the spring 8. The spring 8 acts on the valve element 7 via the guidance element 12.

A sealing ring 22 in form of an O-ring is fitted in a groove 21 on an outer face of the second housing part 3 and prevents external leakage from the nozzle arrangement 1 when the second housing part 3 is screwed into the first housing part 2.

When mounting the nozzle arrangement 1 the valve element 7 is connected to the guidance element 12 by pressing the valve element 7 into the receptacle 13 of the guidance element 12. The orifice disk 10, the cone element 19, and the spring 8are inserted into the first housing part 2. The sealing ring 22 is fitted into the groove 21 on the second housing part 3.

The guidance element 12 together with the valve element 7 is inserted into the bore 16 of the second housing part 3 and the second housing part 3 is screwed into the first housing part 2. In this way all elements of the nozzle arrangement 1 are in the required position.

When the nozzle arrangement 1 is used to atomize a liquid, which is supplied via the inlet channel 18, the pressure of this liquid is increased to a given pressure. The resulting pressure force acts on the valve element 7 in an area which is defined by the inner diameter of the valve seat 6. When the force produced by this pressure exceeds the force produced by the spring 8 the valve element 7 is lifted off the valve seat 6. In this moment the area on which the pressure acts increases suddenly so that the valve element 7 is reliably held in a certain distance from the valve seat 6 and liquid can pass from the inlet channel 18 through the space 17, a cross channel 24 and through channels formed between the cone element 19 and the orifice disk 10 to the orifice 9 in which the liquid is atomized.

Once the atomizing should be terminated, the pressure at the inlet channel 18 is decreased, so that the force of the spring 8 exceeds the force produced by the liquid supplied and the valve closes, wherein the valve element 7 comes into a tight contact with the valve seat 6. Since the valve element 7 is precisely guided by the guidance element 12, the valve is tight.

The orifice disc 10 in this embodiment has the advantage that it is a simple way to change the spray pattern by simply changing the orifice disc 10,

FIG. 3 shows a second embodiment of an atomizing nozzle arrangement in which the same elements are denoted with the same reference numerals.

The nozzle arrangement 1 of FIG. 3 differs from the embodiment shown in FIGS. 1 and 2 in that the orifice 9 is formed directly in the first housing part 2. Furthermore, it is shown that the valve element 7 is lifted off the valve seat 6, so that the valve is open. This has the advantage that only one part, i.e., the second housing part 3, has to be handled during mounting.

In both embodiments the flattened sections 15 of the guidance element 12 can be replaced by grooves on the guidance elements or by grooves in the inner wall of the bore 16.

While the present disclosure has been illustrated and described with respect to a particular embodiment thereof, it should be appreciated by those of ordinary skill in the art that various modifications to this disclosure may be made without departing from the spirit and scope of the present disclosure.

1. An atomizing nozzle arrangement comprising a housing having an inlet, a valve seat, a valve element interacting with the valve seat, restoring means acting on the valve element, and an orifice wherein the valve element is fixed in a guidance element which is guided in a bore of the housing.

2. The nozzle arrangement according to claim 1, wherein at least one flow channel is formed between the guidance element and the housing.

3. The nozzle arrangement according to claim 1, wherein the bore has a circular cross section and the guidance element has a form adapted to the circular cross section with a predetermined tolerance.

4. The nozzle arrangement according to claim 3, wherein the guidance element has at least one flattened section on its circumference, the flattened section extending over the axial length of the guidance element.

5. The nozzle arrangement according to claim 1, wherein the valve element comprises at least on a side facing the valve seat a symmetrically curved surface.

6. The nozzle arrangement according to claim 1, wherein the valve element comprises a spherical surface, at least in an area facing the valve seat.

7. The nozzle arrangement according to claim 1, wherein the valve element is made of an elastically deformable material.

8. The nozzle arrangement according to claim 1, wherein the guidance element comprises a longitudinal channel extending from the valve element to the opposite side of the guidance element.

9. The nozzle arrangement according to claim 1, wherein the valve element is frictionally or in a form-locking way held in the guidance element.

10. The nozzle arrangement according to claim 1, wherein the housing comprises a first housing part and a second housing part, wherein the second housing part comprises an outer thread in engagement with an inner thread in the first housing part, wherein the second housing part comprises an inlet channel connected to the inlet and the valve seat is formed at an inner end of the inlet channel.

11. The nozzle arrangement according to claim 10, wherein the valve seat comprises a conical or curved form.

12. The nozzle arrangement according to claim 1, wherein a cone element is arranged in the housing between the guidance element and the orifice, wherein the restoring means are arranged between the cone element and the guidance element.

13. The nozzle arrangement according to claim 12, wherein the restoring means are arranged in a recess in the cone element and/or in a recess in the guidance element.

14. The nozzle arrangement according to claim 12, wherein a nozzle arrangement comprises a housing having an inlet, a valve seat, a valve element interacting with the valve seat, restoring means acting on the valve element, and an orifice, wherein the valve element is fixed in a guidance element which is guided in a bore of the housing, wherein the housing comprises a first housing part and a second housing part, wherein the second housing part comprises an outer thread in engagement with an inner thread in the first housing part, wherein the second housing part comprises an inlet channel connected to the inlet and the valve seat is formed at an inner end of the inlet channel or wherein the valve seat comprises a conical or curved form, wherein the cone element is held in the first housing part by means of the second housing part.

15. The nozzle arrangement according to claim 1, wherein the bore comprises at least one groove extending over the length of the bore.

16. The nozzle arrangement according to claim 2, wherein the bore has a circular cross section and the guidance element has a form adapted to the circular cross section with a predetermined tolerance.

17. The nozzle arrangement according to claim 2, wherein the valve element comprises at least on a side facing the valve seat a symmetrically curved surface.

18. The nozzle arrangement according to claim 3, wherein the valve element comprises at least on a side facing the valve seat a symmetrically curved surface.

19. The nozzle arrangement according to claim 4, wherein the valve element comprises at least on a side facing the valve seat a symmetrically curved surface.
